(19) United States
(12) Patent Application Publication
(10) Pub. No.: US 2012/0069566 A1
(43) Pub. Date: Mar. 22, 2012

(54) ILLUMINATION APPARATUS WITH HEAT DISSIPATING TUBES

(75) Inventors: HSIN-FEI HUANG, Chu-Nan (TW); ZHENG-JAY HUANG, Chu-Nan (TW); PING-YU CHEN, Chu-Nan (TW)

(73) Assignee: FOXSEMICON INTEGRATED TECHNOLOGY, INC., Chu-Nan (TW)

(21) Appl. No.: 13/300,626

(22) Filed: Nov. 20, 2011

Related U.S. Application Data
(66) Substitute for application No. 12/862,766, filed on Aug. 25, 2010, now abandoned.

(51) Int. Cl. F21V 29/00; F21S 4/00; F21V 5/04

(52) U.S. Cl. 362/235; 362/249.02

(57) ABSTRACT

An illumination apparatus comprises a housing, a LED base, and a heat sink, the housing having a light emitting surface and a heat dissipation surface opposite to the light emitting surface, the LED base including a circuit board and a plurality of LED chips, the heat dissipation surface adjacent to the circuit board, the light emitting surface of the LED chips toward the light emitting surface of the housing, and the heat sink including a plurality of heat dissipating tubes. The heat dissipating tubes are interlaced on the heat sink and the heights of the heat dissipating tube are different.

### BACKGROUND

1. Technical Field

The present disclosure generally relates to an illumination apparatus and particularly to an illumination apparatus with a LED.

2. Description of the Related Art

Light emitting diodes (LEDs) have many advantages, such as high luminosity, low operational voltage, low power consumption, compatibility with integrated circuits, easy driving, long term reliability, and environmental friendliness; thus, LEDs have been widely promoted as a light source.

However, the light emitting diode produces considerable heat during high power operation, and thus requires a heat sink to dissipate the heat and extend the lifetime of the LED. A frequent arrangement of heat dissipating tubes of a heat sink is that they all have substantially the same height and arranged in an array. This arrangement, however, can obstruct the flow obstructed by the outside heat dissipating tube. Efficiency of the inside heat dissipating tubes is, correspondingly, lower than the outside heat dissipating tubes, affecting overall heat dissipating efficiency.

### BRIEF DESCRIPTION OF THE DRAWINGS

Many aspects of the present illumination apparatus can be better understood with reference to the following drawings. The components in the drawings are not necessarily drawn to scale, the emphasis instead being placed upon clearly illustrating the principles of the present illumination apparatus. Moreover, in the drawing, like reference numerals designate corresponding parts throughout the several views.

FIG. 1 is a perspective view of an illumination apparatus in accordance with a first embodiment.

FIG. 2 is a lateral view of the illumination apparatus of FIG. 1.

FIG. 3 is a top view of the illumination apparatus of FIG. 1.

### DETAILED DESCRIPTION

Embodiments of an illumination apparatus are described in detail here with reference to the drawings.

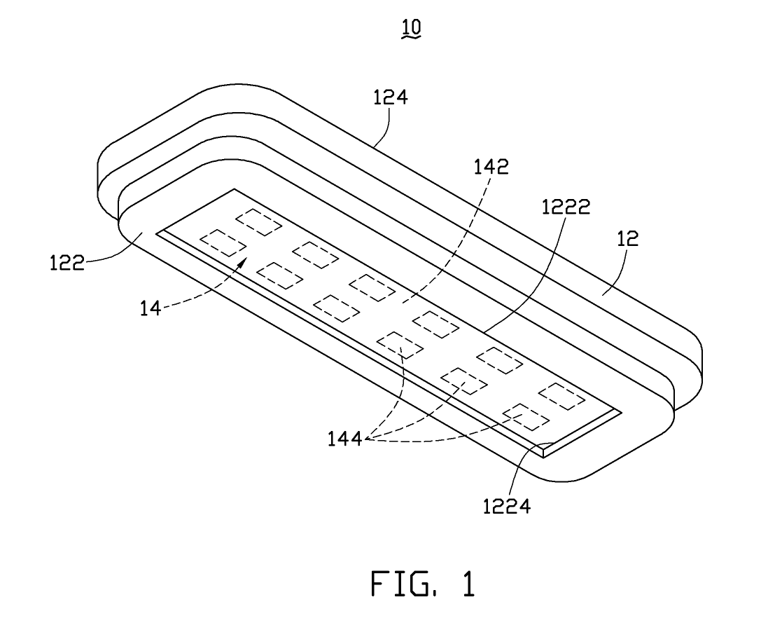

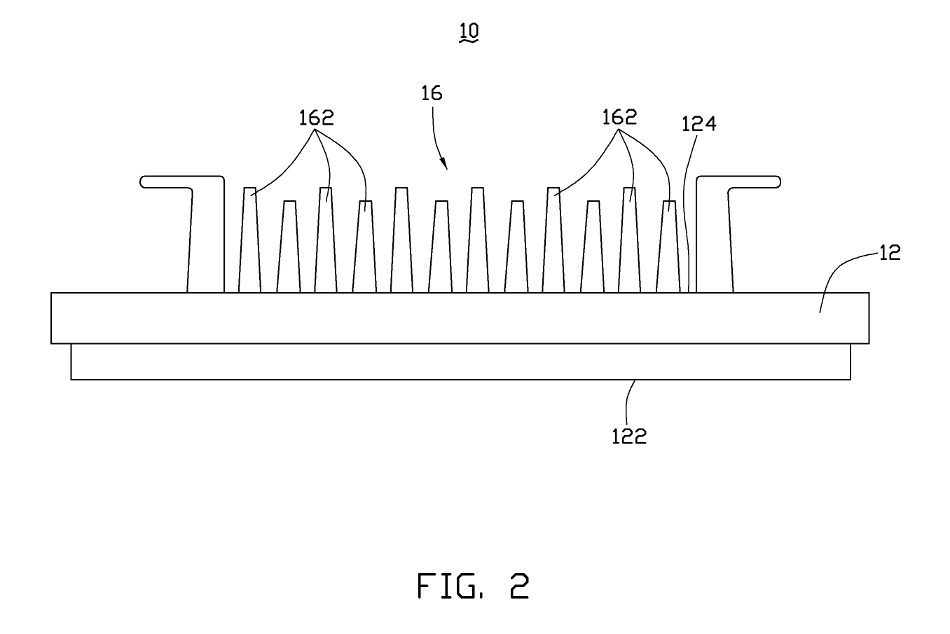

Referring to FIG. 1, an illumination apparatus 10 in accordance with a first embodiment includes a housing 12, a LED base 14, and a heat sink 16 (as shown in FIG. 2). The LED base 14 and the heat sink 16 are respectively arranged on two sides (i.e., top and bottom sides) of the housing 12.

The housing 12 has a light emitting surface 122 and a heat dissipating surface 124 opposite to the light emitting surface 122. The light emitting surface 122 of the housing 12 defines a cavity 1222 inside which the LED base 14 is mounted. The heat sink 16 is mounted on the heat dissipating surface 124 of the housing 12. The housing 12 further includes a lens 1224. The lens 1224 is mounted on one side of the light emitting surface 122 of the housing 12 and opposite to and covering the cavity 1222.

The LED base 14 includes a circuit board 142 and a plurality of LED chips 144 mounted thereon. The circuit board 142 and the plurality of LED chips 144 are arranged in the housing 12. The circuit board 142 is adjacent to the heat dissipation surface 124. The LED chips 144 electrically connect to the circuit board 142. The circuit board 142 is a thermal dissipation substrate having good thermal conductivity for evacuating heat from the LED chips 144. The circuit board 142 can be a Metal Core PCB. The LED chips 144 are mounted on the circuit board 142 in array for high power illumination. The heat sink 16 has a plurality of heat dissipating tubes 162 separated and interlaced on the heat dissipation surface 124. Enhanced separation of the heat dissipating tubes 162 improves airflow and increases the heat exchange rate. Moreover, the thermal dissipation efficiency of the inside heat dissipating tube 162 essentially equals the outside heat dissipating tube 162.

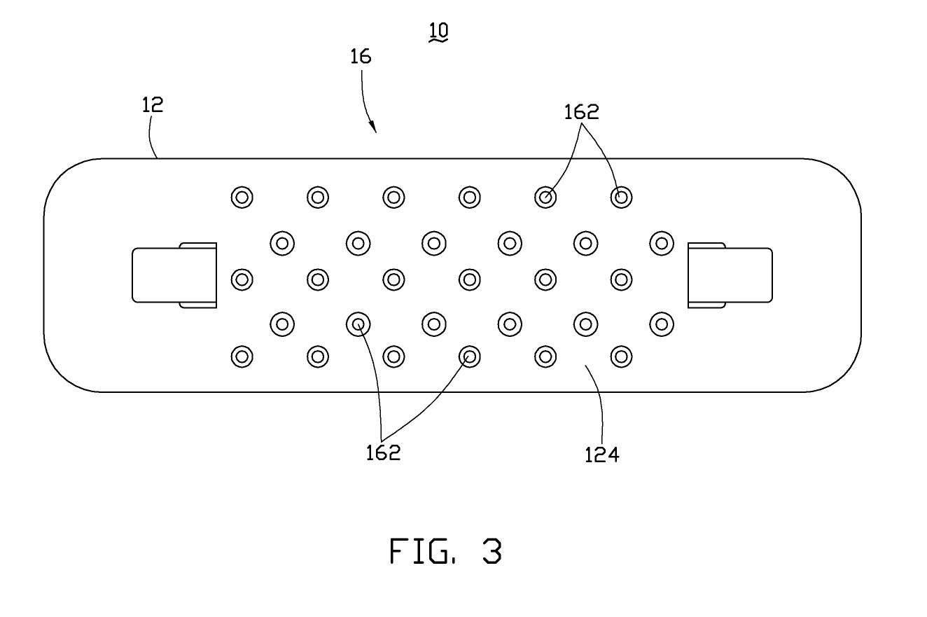

Referring to FIGS. 2 and 3, heights of the heat dissipating tubes 162 are different. The heat dissipating tubes 162 corresponding to the LED chips 144 are higher than the heat dissipating tubes 162 corresponding to the position between two adjacent columns of the LED chips 144. Due to the different heights of the heat dissipating tubes 162, heat dissipating efficiency varies corresponding to the position of the LED chips 144. Thus, the heat sink 16 has a uniform heat dissipation surface 124.

The heat from the LED chips 144 passes through the circuit board 142 to the heat dissipation surface 124 and is uniformly conducted by the differing heights of the heat dissipating tubes 162. Heat exchange rate increases and temperature of illumination apparatus is reduced accordingly.

While certain embodiments have been described and exemplified above, various other embodiments from the foregoing disclosure will be apparent to those skilled in the art. The disclosure is not limited to the particular embodiments described and exemplified but is capable of considerable variation and modification without departure from the scope of the appended claims.

What is claimed is:

1. An illumination apparatus comprising:
a housing, a LED base, and a heat sink, the housing comprising a light emitting surface and a heat dissipation surface opposite to the light emitting surface, the LED base including a circuit board and a plurality of LED chips, the heat dissipation surface adjacent to the circuit board, light emitting surfaces of the LED chips toward the light emitting surface of the housing, and the heat sink including a plurality of heat dissipating tubes, interlaced on the heat sink at varying heights.

2. The illumination apparatus of claim 1, wherein the light emitting surface of the housing defines a cavity in which the LED base is arranged.

3. The illumination apparatus of claim 1, wherein the housing includes a lens mounted on the light emitting surface of the housing and covering the cavity.

4. The illumination apparatus of claim 1, wherein the circuit board is a thermal dissipation substrate on which the LED chips are mounted in array.

5. The illumination apparatus of claim 1, wherein the circuit board is a Metal Core PCB.

6. The illumination apparatus of claim 1, wherein the heat dissipating tubes are interlaced corresponding to the array of the LED chips, and the heat dissipating tubes located corresponding to the LED chips are higher than the heat dissipating tubes corresponding to the position between two adjacent columns of the LED chips.
